(19) United States
(12) Patent Application Publication
(10) Pub. No.: US 2003/0014961 A1
(43) Pub. Date: Jan. 23, 2003

(54) Compact rotary ramjet engine with rapidly interchangeable cartridge containing hot section rotating elements

(75) Inventors: Shawn P. Lawlor, Redmond, WA (US); Steve B. Kushnick, Marietta, GA (US)

Correspondence Address: R REAMS GOODLOE JR, 10725 SE 256TH STREET, SUITE 3, KENT, WA, 980316426

(73) Assignee: RAMGEN POWER SYSTEMS, INC.

(21) Appl. No.: 09/912,244

(22) Filed: Jul. 23, 2001

(51) Int. Cl. F02K 7/10

(52) U.S. Cl. 60/39.35; 60/767

(57) ABSTRACT

A rotary ramjet engine with rapidly replaceable rotating cartridge. A rotary ramjet engine is provided operating with replaceable rotating cartridge. The rotating cartridge includes a rotor and shaft mounted for rotary motion with respect to an engine case, and a first and second bearing package. The engine has an inlet duct assembly including bearing support structures from which the rotating cartridge is rotatably supported. A hot section assembly is sealingly but releaseably affixed to the inlet duct assembly. By disengaging the hot section assembly from the inlet duct assembly, and moving the hot section assembly from an operating position to an inspection position along a convenient slide track, space is provided for inspection and/or removal and reinstallation of the rotating cartridge.

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to rotary ramjet engines, and more particularly, to configurations for such engines, which reduce the labor, and logistical requirements for field disassembly and repair of the rotating components.

### BACKGROUND

Significant reductions in overall energy production costs are anticipated in a new class of power plants. In particular, the goal of greatly increased net cycle efficiency is anticipated in rotary ramjet engines, and more particularly in rotary ramjet engines that have a rotor and shaft journaled with respect to a static housing and engine casing. Moreover, it has been a recent objective of Ramgen Power Systems, Inc., of Bellevue, Wash., U.S.A., the leading innovator in supersonic ramjet engines, to develop a low cost, reliable, and easily maintainable engine for use in a variety of applications. One very important anticipated use of such engines is for relatively small, distributed stationary power plant applications. Such applications might include, for example, use in small business parks, or on remote islands. Therefore, of primary importance to the end user is the logistical support required to maintain such engines, which, due to their unique design features, conceivably will be utilized in isolated areas where conventional maintenance shops and associated manpower and supplies are virtually non-existent. Under such conditions, it will be of importance that the engines be easily maintainable, so that repairs required in the field are significantly reduced. Consequently, such rotary ramjet engines should be of a design that is readily repairable in limited working space, and in isolated areas away from service shops where manpower may be limited, and where the available tools may be considerably less than found in conventional stationary power plant operations.

Therefore, it is a primary object of this invention to provide a rotary ramjet engine having a rotating cartridge with (1) rotor including combustor hot section and (2) bearing structure, wherein the rotating cartridge is removable and replaceable in the field by a small team with a minimum of special tools.

It is also an object of this invention to provide a rotary ramjet engine with a rotating cartridge that is removable and replaceable in the field with significantly reduced down time, for example, by simple fastener disengagement and slidable movement of the hot end assembly including the engine casing, at the installation location, rather than by removal of the casing such as is usually necessary with split casing stationary turbine engine designs.

Other aspects of various embodiments will become apparent to those skilled in the art from the foregoing and from the detailed description that follows and the appended claims, evaluated in conjunction with the accompanying drawings.

### SUMMARY

One embodiment of a rotary ramjet engine includes (1) an inlet duct assembly for air inflow and fuel mixing, (2) a hot end assembly with engine casing that is openable on at least one end, and (3) a rotating cartridge having an output shaft journaled for rotary movement with respect to the inlet duct assembly and the hot end assembly. The rotating cartridge includes a rotor having at least one ramjet on the periphery of the rotor, comprising (a) a compression inlet, (b) a combustor, and (c) an outlet nozzle. In one embodiment, the rotating cartridge further includes a bearing package containing not only the rotating bearing portion(s), but also a stationary bearing portion(s). The bearing package is detachably affixable to a bearing housing(s) in the inlet duct assembly. Further, where a pre-swirl impeller is utilized for increasing the velocity and/or the pressure of inlet air, the pre-swirl impeller may also advantageously be included with the rotating cartridge.

To provide for removal of the rotating cartridge, the hot end assembly is mounted in an axially displaceable fashion, wherein the hot end assembly is moveable between a first, operating position wherein the hot end assembly is configured for engine operation, and a second, open position, wherein the hot end assembly is disconnected from the inlet duct assembly to at least partially expose the rotating cartridge. The initial step in replacement of the rotating cartridge involves disengaging fasteners connecting a portion of, e.g., the inlet plate of the inlet duct assembly, with the engine-casing portion of the hot end assembly. Next, the hot end assembly of the engine is moved axially away from the inlet duct assembly end. In one embodiment, rail(s) or slide track(s) are provided for displaceable mounting of the hot end assembly. Note, however, that the disconnection and reconnection of various ducts (such as the exhaust ducting) and related utility piping and wiring is not addressed, as such components can be easily addressed by one of ordinary skill in the art and to whom this disclosure is addressed.

To facilitate removal of the rotating cartridge, the fuel seal cartridge assembly portions are unbolted, split (if necessary), and removed from the first bearing plate. In one embodiment, a tool in the form of a quill shaft is axially mounted at the rear hub of the output shaft to support the rotating cartridge. Then, the rotating cartridge is extracted utilizing a support cradle. In one embodiment, the cradle is provided to slide on the possibly integral maintenance tracks. Where and as necessary, jacking bolts facilitate the extraction of the rotating cartridge.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

FIG. 1 provides a partial cross-sectional view of the rotating assembly of a rotary ramjet based power plant apparatus according to the present invention, showing a rotating output shaft affixed to a rotor having a ramjet combustor on the periphery thereof, and showing the output shaft delivering rotary motion through a gearbox to an electrical generator.

FIG. 2 is a side elevation view of a fully assembled power plant apparatus of the type first illustrated in FIG. 1 above, showing, from right to left, a starter motor, an electrical generator, a gear box, a shaft coupling, an inlet air plenum, the basic rotary ramjet engine in an engine casing, and an impulse turbine casing.

FIG. 3 is an partial exploded perspective view showing in enlarged detail the basic rotary ramjet engine with a removable rotating cartridge, shown being utilized in a configuration with optional gear drive to delivery energy captured from an exhaust outlet turbine, and with optional steam cycle turbine blades on the exhaust outlet turbine.

FIG. 4 is perspective view of the rotary ramjet engine as first illustrated in FIG. 1 above, now showing the fully assembled skid in an operating configuration, with the rotating cartridge fully concealed, and without showing interconnecting piping, ductwork, and wiring for utilities, inlet air, exhaust gas, and output power being delivered to and from the skid, as appropriate.

FIG. 5 is perspective view of the rotary ramjet engine as similar to the view just provided in FIG. 4 above, now showing the fully assembled skid in a rotating cartridge service configuration, with the ramjet hot section elements on the rotor now open for inspection, and from which position the removal of the rotating cartridge begins.

FIG. 6 is a perspective view of the rotating cartridge being removed from the inlet air assembly; also shown is the removal of a split casing type shaft fuel seal cartridge, as having been removed from the output shaft of the rotating cartridge, so that the rotating cartridge is then free for removal.

FIG. 7 is a side elevation view of the rotating cartridge, illustrating the components which are removable together in a single package, including the rotor, the rim segments on the rotor, which rim segments comprise one or more ramjet engine inlets, combustors, and nozzles, one or more stationary bearing housings, a pre-swirl impeller, and an output shaft.

FIG. 8 is a detailed perspective of a portion of the rim segments on the rotor just illustrated in FIG. 7, now showing outlet nozzle of the ramjet engine which may be easily inspected in the engine casing design illustrated herein.

In the drawing, identical structures shown in the several figures will be referred to by identical reference numerals without further mention thereof.

### DETAILED DESCRIPTION

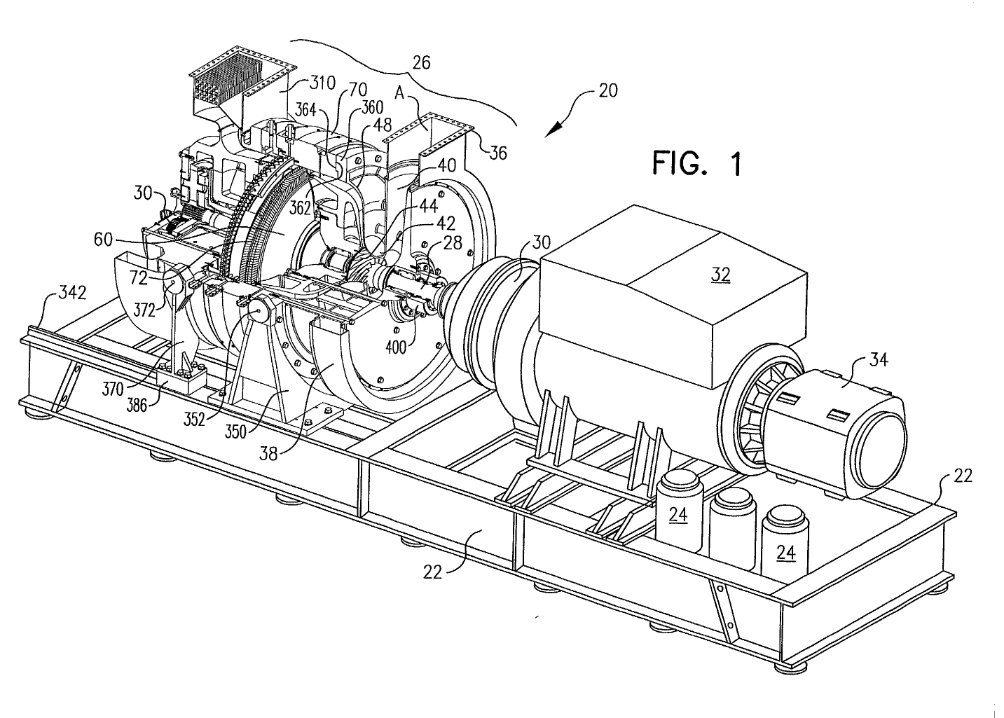

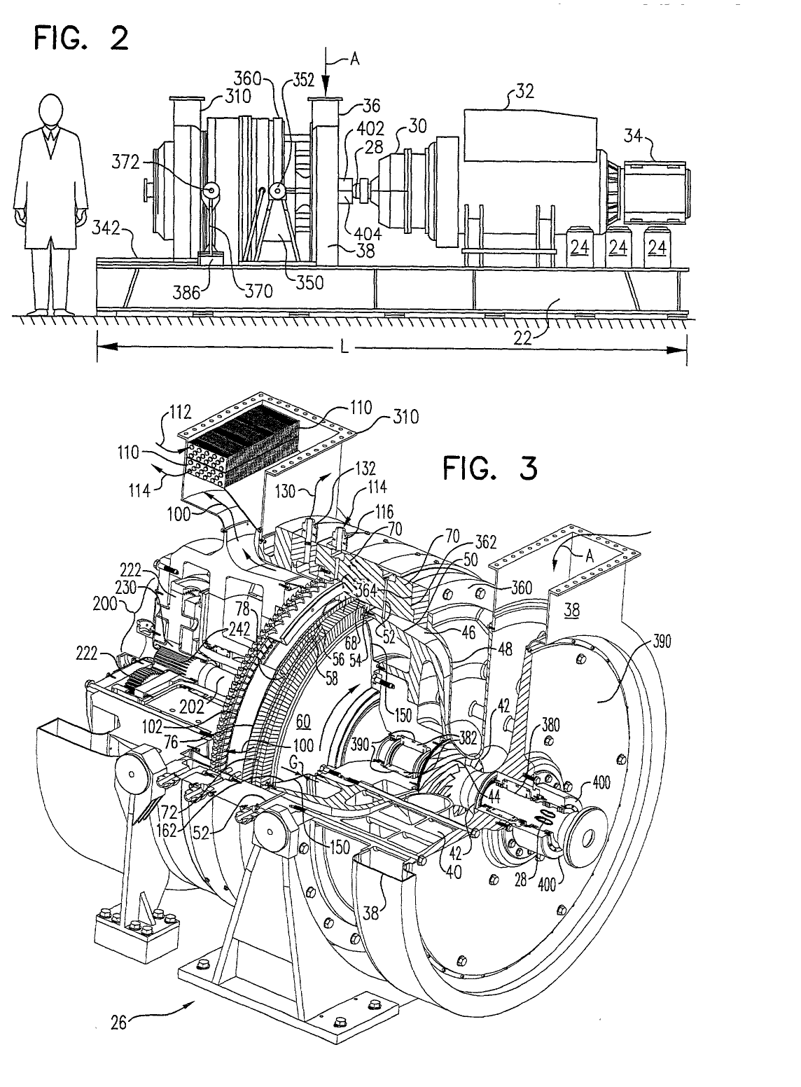

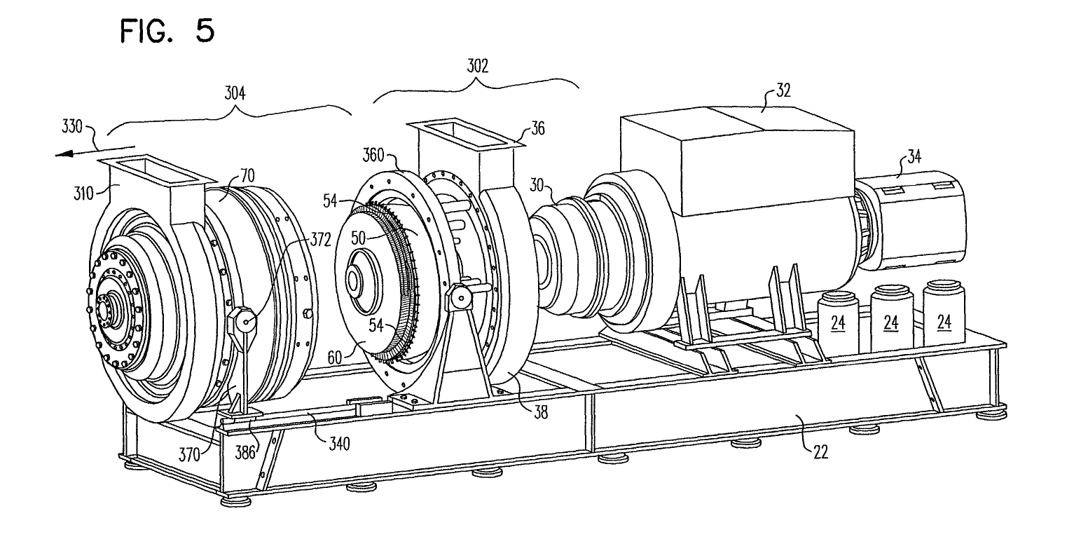

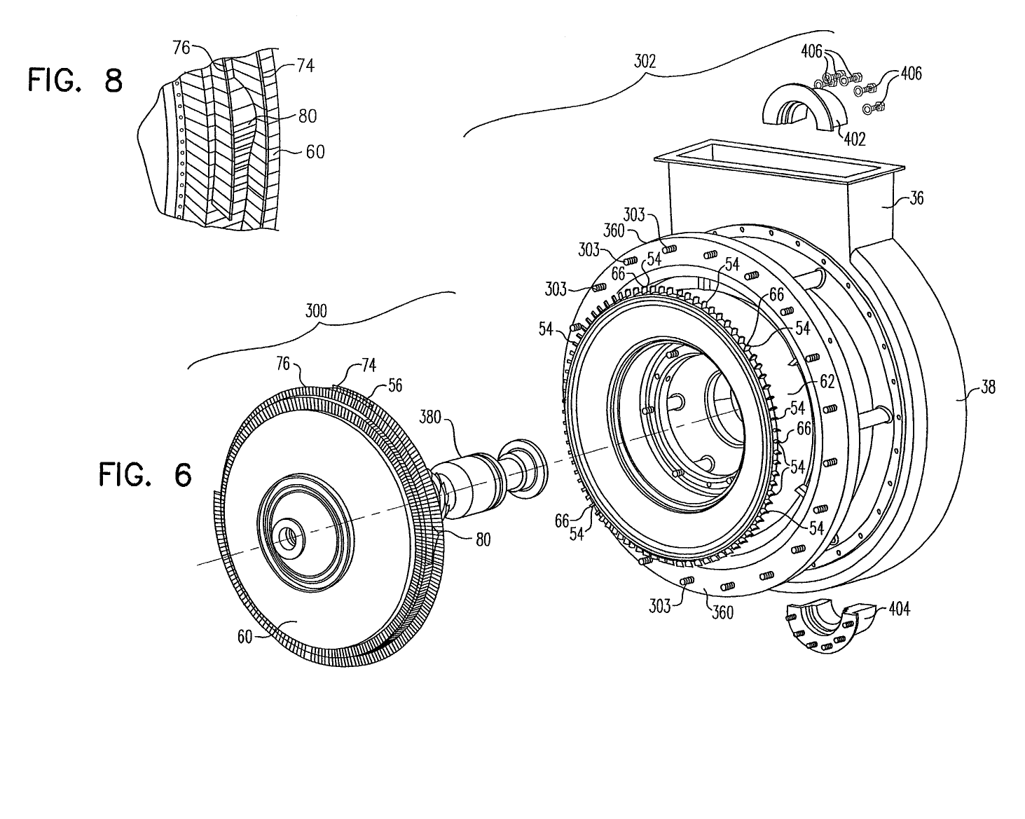

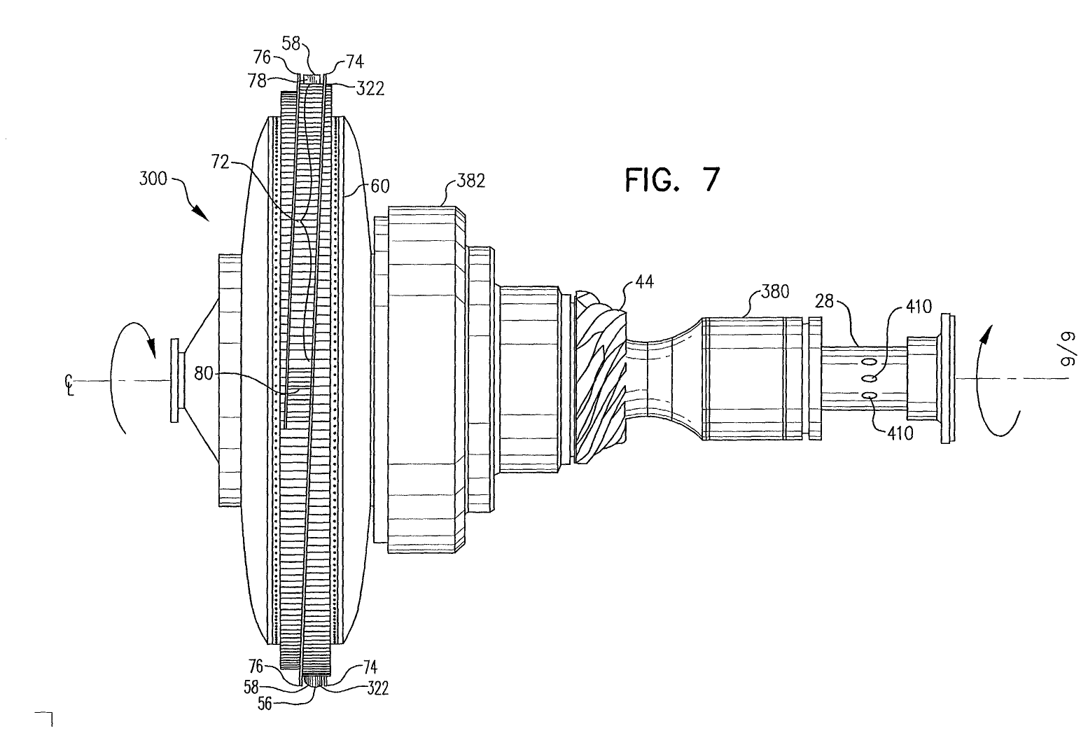

A perspective overview of an exemplary compact electrical generator set 20 based on the use of a rotary ramjet engine is provided in FIG. 1. Components shown include the frame skid 22 with integral lubrication oil reservoir and adjacent lube oil pumps 24, the compact rotary ramjet engine 26 with output shaft 28, a gearbox 30, an electrical generator 32, and a starter motor 34. Inlet air as indicated by reference letter A is supplied via inlet duct 36 to a circumferential inlet air supply plenum 38 and thence inward through a substantially radial air inlet 40 for supply to a pre-swirl compressor inlet 42. From compressor inlet 42 a pre-swirl compressor 44 provides compression of the inlet air A. As better seen in the detailed rotary ramjet engine embodiment illustrated in FIG. 3, the compressed inlet air is allowed to decelerate in a diffuser portion 46 of pre-swirl compressor outlet duct 48, to build a reservoir of low velocity pressurized inlet air. Subsequently, converging portion 50 of outlet duct 48 accelerates inlet air. Fuel is provided by the primary fuel injectors 52. Then, the resultant fuel air mixture is deflected by inlet guide vanes 54 (see FIGS. 5 and 6) to provide both axial and tangential ramjet inlet velocities as required to produce, at design conditions, a negligible inflow angle of attack at the leading edge 56 of one or more ramjet inlet centerbody(s) 58 located defined about rotor 60. The aft end of the converging portion 50 of outlet duct 48 includes an inner circumferential wall 62 from which extends radially outward the plurality of circumferentially spread apart inlet guide vanes 54, the outer ends 66 of which engage an outer circumferential wall 68 (preferably provided in engine casing 70) so as to define an annular inlet flowpath between the inner 62 and outer 68 walls.

For a rotary ramjet engine 26, in one embodiment a supersonic ramjet inlet utilizes the kinetic energy inherent in the air mass or fuel/air premix which is present due to the relative velocity between the leading edge 56 of the ramjet inlet centerbody 58 and the supplied air or fuel/air premix stream, by compressing the inlet air (or, alternately, the inlet fuel/air mixture), preferably via an oblique shock wave structure. Utilizing the inlet centerbody 58 design illustrated herein, in order to carry out reliable thorough combustion in the combustion chamber 72, the inlet stream is compressed utilizing a shock wave flow pattern operating with compression primarily laterally with respect to the plane of rotation of the rotor 60, to compress the inlet fuel/air mix between the inlet centerbody 56 and, functionally in the region of the inlet, the adjacent inlet 74 and outlet 76 strake structures. In the rotary ramjet engine 26 shown herein, compression and combustion is preferably achieved utilizing a small number of ramjets, (normally expected to be in the range from 2 to 5 total, with accompanying functional inlet and outlet strake structures), and within an aerodynamic duct defined laterally by the spirally disposed, or more specifically, helically disposed strakes which function as inlet 74 and outlet 76 strakes. Such a design is simplified compared to a traditional gas turbine or other axial flow compressor which utilizes many rotor and stator blades.

In order to stabilize the combustion process downstream of the rear wall 78 of inlet centerbody 56, the velocity through the combustion chamber 72 is substantially reduced by providing a combustion chamber 72 having larger flow area than provided by the inlet ducts thereto. High energy products of combustion exit the combustor 72 at high speed through an outlet nozzle 80 to propel the rotor 60 at the desired rotary speed under design load conditions. Accordingly, in the ramjet engine configuration illustrated, the acceleration and deceleration of the inlet fluid, and the acceleration and deceleration of the high-energy products of combustion, is accomplished efficiently.

In the embodiment illustrated in FIGS. 1 and 3, the high energy products of combustion, as indicated by reference arrow 100, after discharge from the combustion chamber 72 flow through a ramjet outlet nozzle 80, and thence along the outlet strake 76, and are directed, preferably at low pressure but still containing axial and tangential swirl kinetic energy, to exhaust gas blades 102 in a exhaust turbine 104, for extraction of the kinetic energy based on the overall swirl energy inherent in such exhaust gas products 100.

With respect to the exhaust gas blades 102 of the exhaust turbine 104, the exhaust flow has a high degree of recoverable kinetic energy from the exhaust gas swirl. This is because the exhaust gas flow has been expanded, in leaving the ramjet outlet nozzle 80, to near atmospheric pressure. Thus, a preferred turbine stage for extracting the remaining energy is designed to capture and convert the swirl velocity into useable mechanical power, and preferably avoids additional complexity of appreciable pressure decrease or expansion of the exhaust gas flow stream. In other words, one desirable apparatus for use in this application is a constant-pressure or substantially (although not necessarily exclusively) an impulse type turbine.

For enhanced efficiency, the hot exhaust gases 100 can be further utilized by capturing thermal energy therein by being directed to an exhaust heat exchanger 110 to heat condensate 112 and produce high-pressure steam 114. The high pressure steam 114 is directed through high-pressure steam supply ports 116 and thence through steam inlet vanes (nozzles) 118, preferably fixed in orientation, and thence into the steam buckets 120 in the impulse turbine 104, for added energy recovery. Subsequently, low pressure steam 130 is exhausted from the impulse turbine 104 via steam discharge ports 132 and is directed to a condenser and then pumped (conventional components not illustrated) to the exhaust heat recouperater, i.e., heat exchanger 110 for replenishment of the supply of high pressure steam 114, for supply to the high pressure steam supply nozzles 116 mentioned above.

It should also be noted that in order to minimize aerodynamic drag and efficiently operate the outer portions of the rotor 60 at supersonic tangential velocities, means are preferably provided to reduce drag of the rotor 60. This can take the form of a fixed housing 150 with a small interior gap G between the rotor surface 160 and an interior 162 of housing 150, or, alternately, take the form of a vacuum means to remove air from adjacent the rotor 60.

Also evident in FIGS. 1 and 3 is the use of a planetary gear system for transmitting the power captured by the exhaust turbine. It is desirable to match the tangential speed of rotor 60 and the desired rotational speed of exhaust turbine 104. Where the exhaust turbine 104 is not directly affixed to and turns at a different speed than rotor 60. Also, in order to achieve the desired energy recovery, the exhaust turbine 104 rotates in the opposite direction from, and at lower speed than, the ramjet rotor 60. In one embodiment, this configuration is advantageously achieved via use of a planetary gear set 200 incorporated into the rotary ramjet engine 26 for transmitting power from exhaust turbine 104 to output shaft 202. This gear configuration achieves the required reversal of rotation, while coupling the power output from the exhaust turbine 104 directly to an output shaft portion 202 that is directly affixed to rotor 60 of the ramjet engine 26. In an exemplary embodiment, a ring gear 220 is provided that drives a plurality of planetary gears 222, that reverse the force direction, and increase the angular velocity from the ring gear 220, and transfer rotational energy to a sun gear 230, so that the speed of shaft portion 202 matches the pre-selected speed of the high speed output shaft portion 240. The shaft portion 202 is ideally provided with splines 242 that are adapted for meshing engagement with a matching spline set in the interior of sun gear 230.

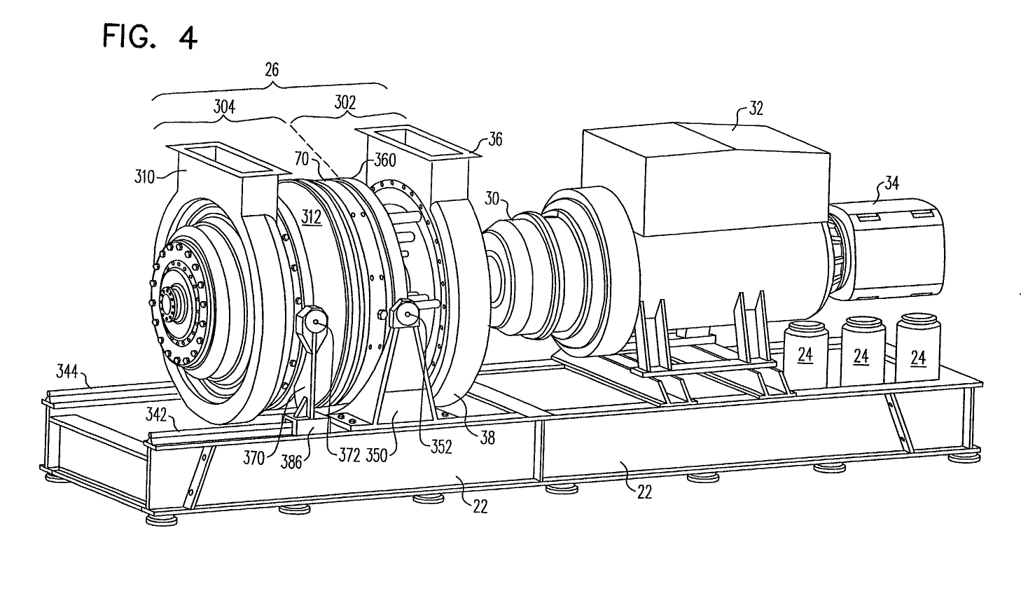

Referring now to FIGS. 4, 5, and 6, the details of an exemplary design configuration that provides for easy interchangeability of a rotating cartridge 300 are illustrated. As noted in FIG. 4, the ramjet engine 26 has two basic static components, namely an inlet duct assembly 302 for air inflow and for fuel mixing, and a hot end assembly 304. The hot end assembly 304 includes the engine casing 70 and an exhaust gas duct 310. Also, when an impulse turbine 104 is provided, the hot end assembly 304 includes an exhaust turbine casing portion 312. As clearly indicated in FIG. 7, the removable rotating cartridge 300 has an output shaft 240 with a longitudinal axis (see centerline noted). The rotating cartridge 300 has a rotor 60 having on the periphery 322 thereof at least one ramjet, preferably defined by a ramjet inlet centerbody 58. Each of the at least one ramjets has a compression inlet (such as is provided by sidewalls 324 that laterally deflect an inlet fluid toward inlet 74 and outlet 76 strakes in the region adjacent leading edge 56 of centerbody 58), and a combustor portion 72, and an outlet nozzle 80.

As shown in FIG. 3, the rotor 60 and accompanying high-speed shaft 240 of the rotating cartridge 320 are journaled for rotary movement with respect to the inlet duct assembly 302 and with respect to the hot end assembly 304. During operation, the inner wall surface 330 of the engine casing 70 defines a static combustor wall portion. In this manner, the combustor portion 72 on the rotor 60 and the static combustor wall portion, i.e., inner wall surface 330 of the engine casing 70, work together to define a combustor that receives fuel and inlet air and burns said fuel to produce a high energy gas stream that escapes through the outlet nozzle 80 to impart rotary motion to the rotor 60.

For removal of the rotating cartridge, the inlet duct assembly 302 and the hot section 304 assembly are detached from each other. In the embodiment illustrated, after removal of interconnecting fasteners 303, and disengaging relevant utility lines and ductwork (not detailed), the hot section assembly 304 is moved from a first, operating position (as seen in FIG. 4) to a second, service position (as seen in FIG. 5), by moving the hot section assembly 304 in an axially aft direction, as indicated by reference arrow 330 in FIG. 5. Ideally, the inlet air assembly 302 and the hot section assembly 304 are mounted on a common frame skid 22. More helpfully, the skid frame 22 may include a mounting track 340 aligned with the longitudinal axis of the rotating cartridge 300, and the hot end assembly 304 is mounted for sliding movement with respect to track 340. In the embodiment shown in FIG. 4, the track 340 is provided by a pair of rails 342 and 344.

Also as shown in FIGS. 4 and 5, a first generally U-shaped mounting bracket 350 is provided to support the inlet duct assembly 302 on frame 22. The first generally U-shaped mounting bracket 350 has, at or near each of the distal ends of each portion of the “U”, a first pivotal mount 352 and second pivotal mount 354 (not shown, but sufficient if of the 352 mount configuration). The inlet duct assembly 302 is thus secured to the frame 22 via the first 350 and second 352 pivotal mounts and supported by the first U-shaped mounting bracket 350.

To facilitate disconnection of the inlet duct assembly 302 from the hot end assembly 304, the inlet duct assembly 302 may include an inlet plate 360 that is sealingly secured to inlet wall 362 of the engine casing 70 via a plurality of suitable fasteners 303. To provide a proper seal, the inlet plate 360 can be provided with a generally radially extending circumferential flange 362 which is attached via fasteners 303 to a complementary circumferential flange 364 on the said engine casing 70. For structural support, in the embodiment illustrated in FIG. 3, the inlet plate 360 is secured by the first 352 and second 354 pivotal mounts.

The hot end assembly 304 is supported by a second mounting bracket 370, which may be provided in a generally U-shape as above described with respect to the first mounting bracket, or, alternately, in a generally H-shape or via a pair of independent “I” shaped supports as noted in FIGS. 3 and 4. In any event, the second mounting bracket supports the hot section assembly 304 via third 372 and fourth 374 pivotal mounts. Where appropriate, sliding foot pair 386 and 388 are provided to support the second mounting bracket 370 on the rails 342 and 344.

When the hot end assembly 304 is disengaged from the inlet duct assembly 302, and moved to an inspection position, then the rotor 70, including the leading edge 56 of the inlet centerbody 58, the combustor 72, and the outlet nozzle 80, are each freely exposed for easy inspection.

In one configuration, the rotating cartridge 300 includes not only the rotor 70 and shaft 28, but also a first bearing package 380, and a second bearing package 382. The bearing packages include not only any rotating bearing portion, but also the external, stationary bearing cases 384 and 386, respectively. As can be noted in FIG. 3, the first bearing package is releasably affixed to a bearing support structure such as first bearing plate 390, so that the rotating cartridge 300 can be removed with the first bearing package 380 affixed thereto. Likewise, the second bearing package 382 is releasably affixed to a second bearing plate location 392, so that the rotating cartridge 300 can be removed with the second bearing package 382 affixed thereto. Importantly, the rotating cartridge 300 is fully supported and axially secured by the bearing package, including when the hot section assembly 304 is removed from said inlet duct assembly 302 for inspection.

As also noted in FIGS. 6 and 7, a fuel gas seal assembly 400 is provided in split casing portions 402 and 404, detachably affixed to front bearing plate 390, and which must be disconnected by removal of fasteners 406, before the rotating cartridge 300 can be removed. The fuel gas seal assembly 400 is for feed of fuel to the interior of hollow shaft 28 via fuel entrance passageways 410. The fuel gas seal assembly 400 is located forward of the first bearing plate 390 along the longitudinal axis. Once the bearing package(s) 380 and 382 have been released, and the fuel gas assembly 400 is disconnected, the rotating cartridge 300 is removable from the inlet air assembly 302 along the longitudinal axis (see FIG. 7) of the rotating cartridge 300. A shipping cradle or other suitable support can be provided for receiving the rotating cartridge 300 as it is removed from the inlet duct assembly 302. Also, a splined shaft tool (not shown) e.g., also called a “quill shaft”, can be utilized in the interior of shaft 28 for support. Reinstallation of a new, repaired, or replacement rotating cartridge 300 is accomplished by reversing the steps described above for removal.

Although only a few exemplary embodiments and aspects of this invention have been described in detail, various details are sufficiently set forth in the drawing and in the specification provided herein to enable one of ordinary skill in the art to make and use such exemplary embodiments and aspects, which need not be further described by additional writing in this detailed description. Importantly, the designs described and claimed herein may be modified from those embodiments provided without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations of the present invention are possible in light of the above teachings. It is therefore to be understood that within the scope of the appended claims, the invention may be practiced otherwise than as specifically described herein. Thus having described some embodiments of the invention, though not exhaustive of all possible equivalents, what is desired to be secured by letters patent is claimed below. Therefore, the scope of the invention, as set forth in the appended claims, and as indicated by the drawing and by the foregoing description, is intended to include variations from the embodiments provided which are nevertheless described by the broad interpretation and range properly afforded to the plain meaning of the claims set forth below.

1. A rotary ramjet engine, said engine comprising:
(a) an inlet duct assembly for air inflow and fuel mixing;
(b) a hot end assembly with an engine casing openable on at least one end; and
(c) a rotating cartridge module having an output shaft with a longitudinal axis journaled for rotary movement with respect to said inlet duct assembly and with respect to said hot section assembly,
(i) said rotating cartridge comprising a rotor
(ii) said rotor having on the periphery thereof at least one ramjet,
(iii) said ramjet having (A) a compression inlet, (B) a combustor portion, and (C) an outlet nozzle;
(d) said engine casing
(i) comprising an inner wall surface defining a static combustor wall portion,
(ii) said combustor portion and said static combustor wall portion adapted to work together to define a combustor that receives fuel and inlet air and burns said fuel to produce a high energy gas stream which escapes through said outlet nozzle to impart rotary motion to said rotor;
(e) said inlet duct assembly and said hot section assembly releasably connected such that the rotating cartridge module is removable in an axially aft direction by disconnecting said hot section assembly from the inlet air assembly and moving said hot section assembly from a first, operating position to a second, service position.

2. The apparatus as set forth in claim 1, wherein said rotating cartridge module further comprises rim segments defining each of said one or more ramjets.

3. The apparatus as set forth in claim 1, further comprising at least one bearing housing, and wherein said bearing housing is removable with said rotating cartridge module.

4. The apparatus as set forth in claim 1, wherein said inlet air assembly and said hot section assembly are mounted on a skid frame.

5. The apparatus as set forth in claim 4, wherein said skid frame further comprises a mounting track, and wherein said hot end assembly is mounted on said track.

6. The apparatus as set forth in claim 5, wherein said mounting track is aligned, axially, with said longitudinal axis of said rotating module.

7. The apparatus as set forth in claim 5, wherein said track comprises a pair of rails.

8. The apparatus as set forth in claim 5, further comprising a first generally U-shaped mounting bracket affixed to said frame, and wherein said first generally U-shaped mounting bracket has, at or near each of the distal ends of said first U-shaped mounting bracket, first and second pivotal mounts, and wherein said inlet air assembly is secured to said frame at said first and said second pivotal mounts.

9. The apparatus as set forth in claim 8, wherein said inlet air assembly further comprises an inlet plate, and wherein said inlet plate is secured at said first and said second pivotal mounts.

10. The apparatus as set forth in claim 9, wherein said engine casing in said hot section assembly is affixed to said inlet plate of said inlet air assembly via a plurality of fasteners.

11. The apparatus as set forth in claim 8, further comprising a second generally U-shaped mounting bracket affixed to said frame, and wherein said second generally U-shaped mounting bracket has, at or near each of the distal ends of said second U-shaped mounting bracket, third and fourth pivotal mounts, and wherein said hot end assembly is secured to said frame at said third and fourth pivotal mounts.

12. The apparatus as set forth in claim 11, wherein said engine casing of said hot section assembly (a) circumferentially encloses said rotor and (b) extends along said longitudinal axis a distance sufficient that when said hot end assembly, including said engine casing, is displaced from an operating position to an open, inspection position, then said rotor is each freely exposed for inspection thereof.

13. A rotary ramjet engine, said engine comprising:
(a) an inlet housing assembly, said inlet housing assembly comprising a bearing support structure;
(b) a hot section, said hot section comprising an engine casing
(c) a rotating cartridge, said rotating cartridge having a longitudinal axis and comprising
(i) a rotor journaled for rotation within said engine casing,
(ii) an output shaft, and
(iii) a bearing package,
(d) said bearing package releasably affixible within said bearing support structure.

14. The apparatus as set forth in claim 13, wherein said rotating cartridge is fully supported by said bearing package when said hot section is removed from said inlet housing.

15. The apparatus as set forth in claim 14, wherein said rotating cartridge is removable from said inlet housing along said longitudinal axis.

16. The apparatus as set forth in claim 15, wherein said inlet housing comprises a bearing plate, and wherein said inlet housing is releasably affixed to said hot section at said bearing plate.

17. The apparatus as set forth in claim 16, wherein said bearing package is configured for secure axial assembly of said rotating cartridge within said inlet housing.

18. The apparatus as set forth in claim 13, wherein said hot section and said inlet housing are affixed to a frame skid.

19. The apparatus as set forth in claim 18, further comprising rail members affixed to said skid along a longitudinal axis, and wherein said hot section further comprises two or more sliding feet, said sliding feet moveably mounted on said rail members, so that said hot section is moveable from a first, operating position to a second, longitudinally aft service position.

20. A rotating ramjet engine, said engine comprising:
(a) an inlet housing assembly, said inlet housing assembly comprising a bearing support structure;
(b) a hot section, said hot section comprising an engine casing
(c) a rotating cartridge, said rotating cartridge having a longitudinal axis and comprising
(i) a rotor journaled for rotation within said engine casing,
(ii) an output shaft, and
(iii) a bearing package;
(d) said bearing package releasably affixable within said bearing support structure.

21. The apparatus as set forth in claim 20, wherein said inlet housing comprises an inlet plate with a generally radially extending circumferential flange which is attached to a complementary circumferential flange on said engine casing by a plurality of fasteners.

22. The apparatus as set forth in claim 20, wherein said inlet housing comprises a first bearing plate, said first bearing plate adapted for releasably accepting a first one of said at least one bearing packages.

23. The apparatus as set forth in claim 22, wherein said output shaft is at least partially hollow and wherein a shaft wall is provided with a plurality of fuel entrance passageways.

24. The apparatus as set forth in claim 23, further comprising a fuel gas seal, and wherein said fuel gas seal is located forward of said first bearing plate along said longitudinal axis, said fuel gas seal adapted for receiving a gaseous fuel and providing a pressurized compartment surrounding said plurality of fuel entrance passageways in said hollow output shaft.

25. The apparatus as set forth in claim 24, wherein said fuel gas seal comprises a split case, said split case detachably affixed to said first bearing plate.

26. The apparatus as set forth in claim 11, wherein said rotating cartridge is supported by said bearing package when said hot section is removed from said inlet housing.

27. A rotating ramjet engine, said engine comprising
(a) an inlet duct assembly means, said inlet duct assembly means comprising a bearing support structure means;
(b) a hot section assembly means, said hot section assembly means comprising an engine casing means;
(c) a rotating cartridge means, said rotating cartridge means having a longitudinal axis and comprising
(i) a rotor journaled for rotation within said engine casing,
(ii) an output shaft, and
(iii) a bearing package means;
(d) said bearing package means releasably affixable to said bearing support structure means.

28. The apparatus as set forth in claim 27, wherein said rotating cartridge means is removable from said inlet duct assembly means along said longitudinal axis.

29. The apparatus as set forth in claim 27, wherein said bearing support structure means comprises a bearing plate, and wherein said rotating cartridge means is releasably affixed to said bearing plate.

30. The apparatus as set forth in claim 27, further comprising a frame means having rail members affixed to frame means along a longitudinal axis, and wherein said hot end assembly means further comprises two or more sliding feet, said sliding feet moveably mounted on said rail members, so that said hot end assembly means is moveable from a first, operating position to a second, longitudinally aft service position.

31. A method of disassembly for an engine, said engine of the type having
(a) an inlet duct assembly for air inflow and fuel mixing;
(b) a hot end assembly with an engine casing openable on at least one end; and
(c) a rotating cartridge module having an output shaft with a longitudinal axis journaled for rotary movement with respect to said inlet duct assembly and with respect to said hot section assembly,
(i) said rotating cartridge comprising a rotor
(ii) said rotor having on the periphery thereof at least one ramjet,
(iii) said ramjet having (A) a compression inlet, (B) a combustor portion, and (C) an outlet nozzle;
(d) said engine casing
(i) comprising an inner wall surface defining a static combustor wall portion,
(ii) said combustor portion and said static combustor wall portion adapted to work together to define a combustor that receives fuel and inlet air and burns said fuel to produce a high energy gas stream which escapes through said outlet nozzle to impart rotary motion to said rotor;
(e) said inlet duct assembly and said hot section assembly releasably connected;
said method comprising the steps of:
(1) disconnecting said hot section assembly from the inlet air assembly;
(2) removing said rotating cartridge module in an axially aft direction, from a first, operating position to a second, service position.

32. An electrical generator set, said generator set comprising:
(1) a rotary ramjet engine, said engine comprising:
(a) an inlet duct assembly for air inflow and fuel mixing;
(b) a hot end assembly with an engine casing openable on at least one end; and
(c) a rotating cartridge module having an output shaft with a longitudinal axis journaled for rotary movement with respect to said inlet duct assembly and with respect to said hot section assembly,
(i) said rotating cartridge comprising a rotor
(ii) said rotor having on the periphery thereof at least one ramjet,
(iii) said ramjet having (A) a compression inlet, (B) a combustor portion, and (C) an outlet nozzle;
(d) said engine casing
(i) comprising an inner wall surface defining a static combustor wall portion,
(ii) said combustor portion and said static combustor wall portion adapted to work together to define a combustor that receives fuel and inlet air and burns said fuel to produce a high energy gas stream which escapes through said outlet nozzle to impart rotary motion to said rotor;
(e) said inlet duct assembly and said hot section assembly releasably connected such that the rotating cartridge module removable in an axially aft direction by disconnecting said hot section assembly from the inlet air assembly and moving said hot section assembly from a first, operating position to a second, service position;
(2) a shaft driven electrical generator, driven by said shaft of said engine.

33. The apparatus as set forth in claim 32, further comprising a gear set, said gear set adapted to transfer energy from said output shaft to said shaft driven electrical generator while changing rotary speeds therebetween.

34. The apparatus as set forth in claim 32, further comprising an impulse turbine, said impulse turbine adapted to receive hot combustion gases from said engine and to generate power therefrom for delivery to said output shaft.

35. The apparatus as set forth in claim 34, further comprising a gear drive, said gear drive situated between said impulse turbine and said output shaft and adapted to delivery power output from said impulse turbine to said output shaft.

36. The apparatus as set forth in claim 35, wherein said gear drive comprises a planetary gear set.
